(19) United States
(12) Patent Application Publication
(10) Pub. No.: US 2008/0048547 A1
(43) Pub. Date: Feb. 28, 2008

(54) PLASMA DISPLAY DEVICE AND LIGHT EMITTING DEVICE

(76) Inventors: Hitoshi Oaku, Tokyo (JP); Hirotaka Sakuma, Kokubunji (JP); Choichiro Okazaki, Kodaira (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/828,435

(22) Filed: Jul. 26, 2007

(30) Foreign Application Priority Data
Aug. 28, 2006 (JP) JP2006-230595

(51) Int. Cl. H01J 1/62; H01J 17/49

(52) U.S. Cl. 313/486; 313/584

(57) ABSTRACT

A plasma display panel including a discharge gas for generating ultraviolet light as a result of electric discharge, and a phosphor layer containing a phosphor for emitting light upon excitation by ultraviolet light is provided. The phosphor contains a novel Eu-activated silicate phosphor represented by (CaₓM1₁₋ₓ)₃₋ₑ.M2.Si₂O₈: Euₑ. In the formula, M1 is at least one element selected from the group consisting of Sr and Ba; M2 is at least one element selected from the group consisting of Mg and Zn; x is the mole fraction of the component Ca satisfying the condition of 0<x≦0.2, and e is the mole fraction of Eu satisfying the condition of 0.001≦e≦0.2.

### CROSS-REFERENCE TO RELATED APPLICATION

The present application claims priority from Japanese Patent Application No. JP 2006-230595 filed on Aug. 28, 2006, the content of which is hereby incorporated by reference into this application.

### TECHNICAL FIELD OF THE INVENTION

The present invention relates to a light emitting device, in particular, it relates to a light emitting device such as Plasma Display Panel (PDP) using an Eu-activated silicate phosphor which emits light by being excited by ultraviolet light in the vacuum ultraviolet region.

### BACKGROUND OF THE INVENTION

In recent years, demands to reduce the thickness of display devices represented by television sets and monitors for personal computers for saving installation space has been increased. As a display device capable of being slimmed, a plasma display device for displaying images using a plasma display panel with a driver device which drives the PDP, which is thinner than the cathode ray tube as the light emitting device, a liquid crystal display device for displaying images using a fluorescent lamp as the light emitting device in combination with a liquid crystal display panel, and the like have been attracting the attention.

The plasma display panel (PDP) as the light emitting device comprised in the plasma display device includes micro discharge spaces each containing a rare gas, and a phosphor layer arranged in each micro discharge space. The plasma display panel is so configured as to emit light in the visible region (visible radiation) by exciting a phosphor in the phosphor layer upon irradiation with ultraviolet light emitted in a negative glow region in the micro discharge space as an excitation source and thereby accelerating light emission of the phosphor. Central wavelengths of the main emission of the ultraviolet light are at 146 nm and 172 nm when xenon gas is used as the rare gas. The plasma display deices display images by controlling the intensity (quantity) and color of the light emission of the plasma display panel.

Recently, it is demanded for plasma display devices to realize higher luminance for satisfying the display function, particularly for the television, and furthermore, higher emission efficiency for achieving higher luminance. Moreover, it is required to improve the video characteristics for allowing viewers to comfortably appreciating the video contents such as movies, and to ensure a wide color reproduction range of 100% or more with respect to the NTSC (national television system committee) for enjoying beautiful images. Furthermore, improvement of the reliability for enabling long time use for viewing is also required.

For promoting higher performance of the plasma display devices to satisfy these demands, it is a must to achieve higher performance of PDPs comprised in plasma display devices. Specifically, the high luminance for coping with the display function for the television, the high emission efficiency for achieving the high luminance, improvement of response performance for coping with improvement of video quality, enlargement of color reproduction range, and furthermore, improvement of reliability should be satisfied.

For improvement of performance and characteristics of the PDP, improvement of design and structure and improvement of performances of the members including the PDP play important roles. Improvement of color reproduction performance and improvement of reliability depend largely on the phosphor among the constituent members in particular. Therefore, improvement of emission efficiency, improvement of response characteristics in the light emission, and ensuring of color reproduction property are highly required. Furthermore, performance improvement of deterioration resistance and improvement of reliability are highly required.

As phosphors of the current color PDP, phosphors corresponding to three emission colors of red (R), blue (B) and green (G), in other words, a red-emitting phosphor, a blue-emitting phosphor and a green-emitting phosphor are used. As the blue-emitting phosphor, generally an aluminate phosphor (BaMgAl₁₀O₁₇:Eu, hereafter, it is referred to as BAM) is used. BAM has excellent characteristics in its light emission but is susceptible to deterioration. BAM thus has poor reliability and short life and so it is demanded to make improvement of stability, achievement of long life, and realization of higher photoluminescent brightness.

Under such circumstances, as a blue-emitting phosphor having higher reliability and longer life than BAM of conventional blue-emitting phosphor, a silicate phosphor has been proposed. Specifically, Ca₁₋ₓMgSi₂O₆:Euₓ (hereafter, it is referred to as CMS) and Sr₃₋ₓMgSi₂O₈:Euₓ (hereafter, it is referred to as SMS) are proposed (refer to Japanese Patent Application Laid-Open Publication No. 2006-12770 (Patent Document 1)).

### SUMMARY OF THE INVENTION

Meanwhile, due to its insufficiency in brightness compared to BAM and the like, current CMS is demanded to have improvement in brightness.

Moreover, in the technical field of the PDP, with the discussion for achieving high performance of the phosphor materials, improvement of panel structure aiming at high emission efficiency of PDPs has been discussed.

As a specific method thereof, a technique for actively utilizing Xe₂ molecular line (wavelength 172 nm) generated by the electric discharge by increasing the mole fraction of xenon contained in a discharge gas has actively been discussed. Such orientation of the technique is referred to as the trend of the so-called “high Xe-content” technology in PDP. According to the “high Xe-content” technology, achievement of high efficacy PDP panels with a mole fraction of Xe in a regime where the mole fraction of Xe in the discharge gas is higher than about 4% has been generally studied.

CMS mentioned above emits light having relatively high brightness and good color purity upon having ultraviolet light in a wavelength range of 146 nm as the excitation source. However, it is known that the excitation band barely exists in a wavelength range of 160 nm to 210 nm as its excitation characteristics. Therefore, the intensity of emission to be generated by the excitation by vacuum ultraviolet light at the vicinity of 172 nm (Xe₂ molecular line), which is important for the PDP, is extremely low. In other words, since CMS has a low emission efficiency with respect to the Xe₂ molecular line at a wavelength of 172 nm to be increased with respect to the technology trend for achieving high efficacy PDP, the effects of luminance improvement and efficiency improvement cannot be obtained sufficiently. Accordingly, as to the CMS, in addition to the remark for the current insufficient brightness, further improvement in practice, in particular, improvement of emission efficiency in the excitation band of 172 nm wavelength is required upon taking the trend of high efficacy PDP technology into consideration in the future.

The silicate phosphor SMS disclosed in the above-mentioned Patent Document 1 is a promising novel phosphor because it has high brightness characteristics upon an excitation by light at a wavelength of 146 nm and has a good emission efficiency also upon an excitation by light at a 172 nm wavelength as compared to CMS. Furthermore, Patent Document 1 discloses a phosphor with high color purity and good emission efficiency even in the excitation by light at a wavelength of 172 nm by newly adding and composing a Ba component to the SMS as the host material composition and further optimizing its mole fraction.

However, for example, regarding the technology of providing the composition by adding a Ca component to the host material of SMS, Patent Document 1 does not disclose any detailed investigations and corresponding descriptions about a novel and dramatic effect to be achieved by the optimum amount of composition of the Ca component, the range of the limited optimum mole fraction of Ca for attaining the effects, and the like. Thus, there is a room for discussion about the technology for providing a composition by adding another different component to the host material of SMS.

As described above, a problem to be solved by the present invention is the insufficiency of the brightness performance of the silicate phosphor, in particular, of CMS considered to be a substitute for the current BAM as the phosphor for light emitting devices such as PDPs. Furthermore, since CMS has a low emitting efficiency with respect to the Xe₂ molecular line at 172 nm wavelength, the effect of brightness improvement and the effect of efficiency improvement cannot be obtained sufficiently with respect to the trend of high efficacy PDP technology in the technical field of plasma display device.

Moreover, another problem to be solved by the present invention is that not everything has been disclosed about a technology for realizing a high performance novel composition by adding another component of host material to SMS host material to the promising SMS having a preferable emission efficiency even upon excitation by light at a wavelength of 172 nm compared to CMS. In other words, a room is left in terms of developing and disclosing a novel technology with respect to SMS for providing a light emitting device such as PDPs having higher performance.

Accordingly, an object of the present invention is to improve the brightness characteristics of a silicate phosphor such as CMS, SMS, and SMS-based phosphor SMS with improved compositions and the like for improving the luminance characteristics in a light emitting device such as a PDP using these silicate phosphors.

Moreover, another object of the present invention is to realize a phosphor having novel composition and dramatically high performance by investigating the composition of components of an effective novel host-material composition newly and in details with respect to SMS and SMS-based phosphor so as to provide a light emitting device having excellent characteristics using the same such as PDPs.

The above and other objects and novel characteristics of the present invention will be apparent from the description of this specification and the accompanying drawings.

The typical ones of the inventions disclosed in this application will be briefly described as follows.

A plasma display device of the present invention comprises: a pair of substrates arranged at a distance so as to face each other; barrier ribs arranged between the pair of substrates for forming a space between the pair of substrates; an electrode pair arranged on or above at least one of facing sides of the pair of substrates; a discharge gas sealed in the space formed by the barrier ribs for generating ultraviolet light as a result of electric discharge upon application of a voltage to the electrode pair; and a phosphor layer containing a phosphor for emitting light as a result of excitation by the ultraviolet light formed on at least one of the facing sides of the pair of substrates and wall surfaces of the barrier ribs in the space, wherein the phosphor contains an Eu-activated silicate phosphor represented by the following General Formula (1):

(CaₓM1₁₋ₓ)₃₋ₑ.M2.Si₂O₈:Euₑ (1)

wherein M1 is at least one element selected from the group consisting of Sr and Ba; M2 is at least one element selected from the group consisting of Mg and Zn; and x is the mole fraction of the component Ca, and e is the mole fraction of Eu, respectively satisfy the following conditions: 0<x≦0.2, and 0.001≦e≦0.2.

The effects obtained by typical aspects of the present invention will be briefly described below.

A high brightness Eu-activated silicate phosphor having preferable emission efficiency not only excitation by light at a wavelength of 146 nm wavelength but also excitation by light at a wavelength of 172 nm is used, thereby obtaining high brightness.

An Eu-activated silicate phosphor having preferable emission efficiency and preferable color purity not only excitation by light at a wavelength of 146 nm wavelength but also excitation by light at a wavelength of 172 nm is used, thereby realizing the excellent color characteristics in the light emission.

An Eu-activated silicate phosphor having high brightness and preferable color purity is used, thereby realizing high-luminance display and image display with excellent color reproductivity.

### BRIEF DESCRIPTIONS OF THE DRAWINGS

FIG. 1 is a graph showing respective light emission spectra of an Eu-activated silicate phosphor according to the present invention, and of a conventional blue-emitting phosphor and an Eu-activated silicate phosphor not containing Ca as comparative examples, obtained as a result of excitation by vacuum ultraviolet light at a wavelength of 172 nm;

FIG. 2 is a table showing respective analysis data of the emission characteristics and the light emission spectra of the Eu-activated silicate phosphor according to the present invention and the conventional blue-emitting phosphor;

FIG. 3 is a graph showing the relationship between the emission characteristics and the mole fraction of Ca of the Eu-activated silicate phosphor according to the present invention;

FIG. 4 is a graph showing the relationship between the mole fraction of Xe in a discharge gas in an AC plasma display panel and the intensity ratio;

FIG. 5 is an exploded perspective view showing a structure of a plasma display panel according to an embodiment of the present invention;

FIG. 6 is an exploded perspective view showing the structure of main parts of the plasma display panel according to the embodiment of the present invention;

FIG. 7 is an exploded perspective view showing the structure of main parts of the plasma display panel according to the embodiment of the present invention;

FIG. 8 is an exploded perspective view showing the structure of main parts of the plasma display panel according to the embodiment of the present invention; and

FIG. 9 is a graph obtained by plotting the change in sustainment ratio of emission efficiency (%) with time of each of the plasma display panel using the Eu-activated silicate phosphor of the present invention and of a plasma display panel using BAM.

### DESCRIPTIONS OF THE PREFERRED EMBODIMENTS

Hereinafter, embodiments of the present invention will be described in detail with reference to the accompanying drawings. Note that components having the same function are denoted by the same reference symbols throughout the drawings for describing the embodiment, and the repetitive description thereof will be omitted.

As to the relationship between the composition of the discharge gas in the plasma display panel (PDP) and each ultraviolet light intensity generated by the discharge, it is known that, the larger a mole fraction of contained Xe is, the more intensity of the entire vacuum ultraviolet light generated by the discharge is increased and the more ratio of the constituent component in the vacuum ultraviolet light to be emitted is changed. Specifically, it is known that the intensity ratio (I₁₇₂/I₁₄₆) of the 146 nm ultraviolet light component and the 172 nm ultraviolet light (Xe₂ molecular line) component contained in the vacuum ultraviolet light to be generated by the change of the mole fraction of Xe in the discharge gas is changed, that is, with the increase of the mole fraction of Xe, the intensity ratio (I₁₇₂/I₁₄₆) gets larger.

The present invention has realized a novel silicate phosphor capable of achieving remarkably high brightness and high efficiency upon excitation by light at a wavelength of 172 nm. As a result, a PDP was realized as a high luminance, high efficiency novel light emitting device using the novel silicate phosphor. Therefore, by use of the PDP, a novel plasma display device with high efficiency enabling high luminance display can be realized.

The Eu-activated silicate phosphor of the present invention newly realized is an Eu-activated silicate phosphor represented by the following General Formula (1):

(CaₓM1₁₋ₓ)₃₋ₑ.M2.Si₂O_{8:}Euₑ (1)

In the General Formula (1), M1 is at least one element selected from the group consisting of Sr and Ba; M2 is at least one element selected from the group consisting of Mg and Zn; and x is a mole fraction of the component Ca and e is a mole fraction of Eu and respectively satisfy the following condition: 0<x≦0.2, and 0.001≦e≦0.2.

According to the description of the above General Formula (1), the above-mentioned Eu-activated silicate phosphor newly realized may form a host lattice as a composite oxide by containing at least one of Sr and Ba as the host lattice component M1. And at the same time, according to the description of the above General Formula (1), it may form a host lattice as a composite oxide by containing at least one of Mg and Zn as the host lattice component M2.

By activating Eu²⁺ to the host lattice accordingly formed, a blue-emitting phosphor can be provided as a composite oxide capable of efficiently emitting light. Furthermore, by containing a Ca component controlled in an optimum amount range as the host lattice component, emission efficiency and brightness can be remarkably improved compared to the conventional configuration while maintaining color purity at a good level.

Here, the mount of Ca is, according to the description of the above-mentioned General Formula (1), the mole fraction (x) of the phosphor component (Ca) is 0<x≦0.2. However, according to the evaluation results and discussion of the phosphor characteristics to be explained below, particularly in the case where the mole fraction (x) of Ca is 0.001≦x≦0.1, the effect of high brightness is further remarkable, and thus it is preferable. Furthermore, in consideration to further improvement of color purity of the emission, the mole fraction (x) of Ca is preferably 0.001≦x≦0.09. Moreover, in the case where the mole fraction (x) of Ca is 0.02≦x≦0.08, the effect of high efficiency is further remarkable and color purity is further better, and thus it is most preferable.

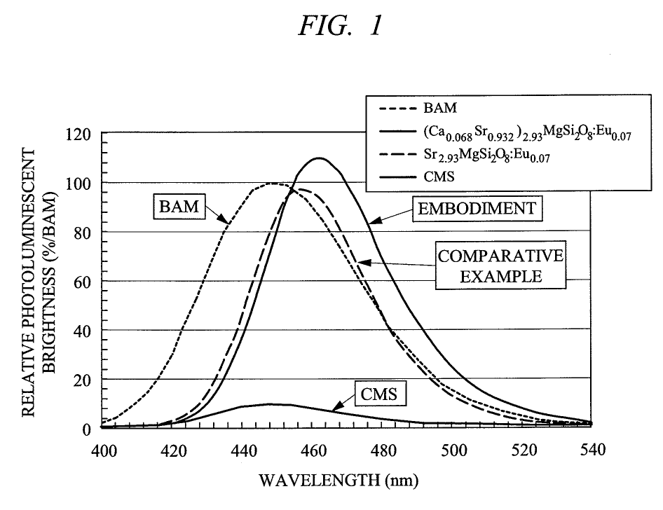

Hereafter, characteristics and evaluation results of the novel Eu-activated silicate phosphor of the present invention will be explained. FIG. 1 shows emission spectra upon excitation by vacuum ultraviolet light at a wavelength of 172 nm of (Ca_{0.068}Sr_{0.932})_{2.93}MgSi₂O₈:Eu_{0.07} as an example of the novel Eu-activated silicate phosphor of the present invention, conventional blue-emitting phosphors BAM and CMS as comparative examples, and a newly synthesized Sr_{2.93}MgSi₂O₈:Eu_{0.07} as an Eu-activated silicate phosphor not containing a Ca component.

The photoluminescent brightness and the spectra were measured according to an ordinary method using a vacuum ultraviolet excimer lamp the central emission wavelength thereof is 172 nm as the excitation light source. For convenience' sake, FIG. 1 shows the emission spectrum of the novel Eu-activated silicate phosphor (Ca_{0.068}Sr_{0.932})_{2.93}MgSi₂O₈:Eu_{0.07} of the present invention as the “embodiment,” the light emission spectra of BAM and CMS as the conventional blue-emitting phosphors respectively as “BAM” and “CMS,” and the emission spectrum of Sr_{2.93}MgSi₂O₈:Eu_{0.07} as another comparative example as “comparative example.”As shown in FIG. 1, (Ca_{0.068}Sr_{0.932})_{2.93}MgSi₂O₈:Eu_{0.07} which is an example of the novel Eu-activated silicate phosphor of the present invention shows good emission also upon excitation by light at a wave length of 172 nm. Moreover, it has the intensity of the maximum of the emission band (Imax) 1.1 times stronger than that of BAM. Therefore, it can be seen that the emission efficiency is remarkably improved upon excitation by light at a wavelength of 172 nm.

Further, as mentioned above, it can be seen that CMS has remarkably low emission efficiency upon excitation by vacuum ultraviolet light at a wavelength of 172 nm with the intensity of the maximum of the emission band (Imax) 0.1 times stronger than that of BAM (more specifically, 0.099 times). That is, in terms of CMS, BAM has the intensity of the maximum of the emission band (Imax) 10.1 times stronger than that of CMS. Accordingly, (Ca_{0.068}Sr_{0.932})_{2.93}MgSi₂O₈:Eu_{0.017} which is an example of the novel Eu-activated silicate phosphor of the present invention obtains the intensity of the maximum of the emission band (Imax) more than 11 times stronger than that of CMS upon excitation by light at a wavelength of 172 nm.

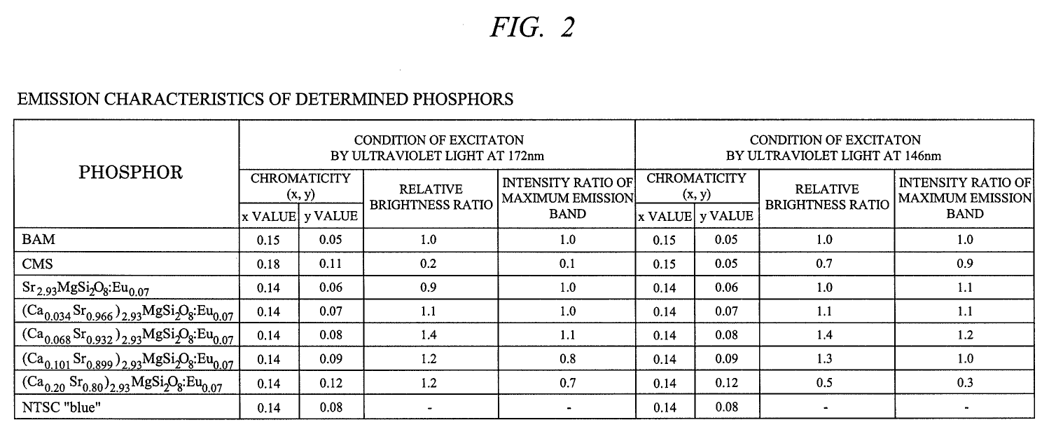

Next, emission characteristics of various phosphors are shown in FIG. 2. Specifically, measurement was carried out for the case of using a vacuum ultraviolet light excimer lamp of 172 nm central emission wavelength as the light source, and the case of using a vacuum ultraviolet light excimer lamp of 146 nm central emission wavelength as the light source. As to the phosphors as the measurement subjects, the photoluminescent brightness and the emission spectrum were measured respectively for the newly synthesized Eu-activated silicate phosphors of the present invention including: (Ca_{0.034}Sr_{0.966})_{2.93}MgSi₂O₈: Eu_{0.07} and (Ca_{0.068}Sr_{0.932})_{2.93}MgSi₂O₈:Eu_{0.07} as examples whose mole fraction of Ca (x) satisfying x≦0.1; (Ca_{0.101}Sr_{0.899})_{2.93}MgSi₂O₈:Eu_{0.07} and (Ca_{0.20}Sr_{0.80})_{2.93}MgSi₂O₈:Eu_{0.07} as examples satisfying x≧0.1; BAM and CMS as the conventional blue-emitting phosphors; and Sr_{2.93}MgSi₂O₈:Eu_{0.07} not containing a Ca component as a comparative example.

Photoluminescent brightness and emission spectrum are obtained by above investigations and analyzed. As a result of the analysis, FIG. 2 is a table showing relative brightness ratio and relative intensity ratio of the maximum of the emission band with respect to the conventional BAM. Moreover, for evaluating color characteristics of the emission by each phosphor, chromaticity in the CIE (International Commission on Illumination) colorimetric scale representing the emission color of the phosphor, and the x value and y value in the (x, y) coordinates were evaluated. Then, they were compared to the blue chromaticity (x, y) defined by the NTSC (National Television System Committee) and arranged in FIG. 2 in the same manner. Therefore, FIG. 2 is a table showing the analysis data of the emission characteristics and emission spectra of the novel Eu-activated silicate phosphors of the present invention and the conventional phosphors (BAM and CMS) are arranged therein.

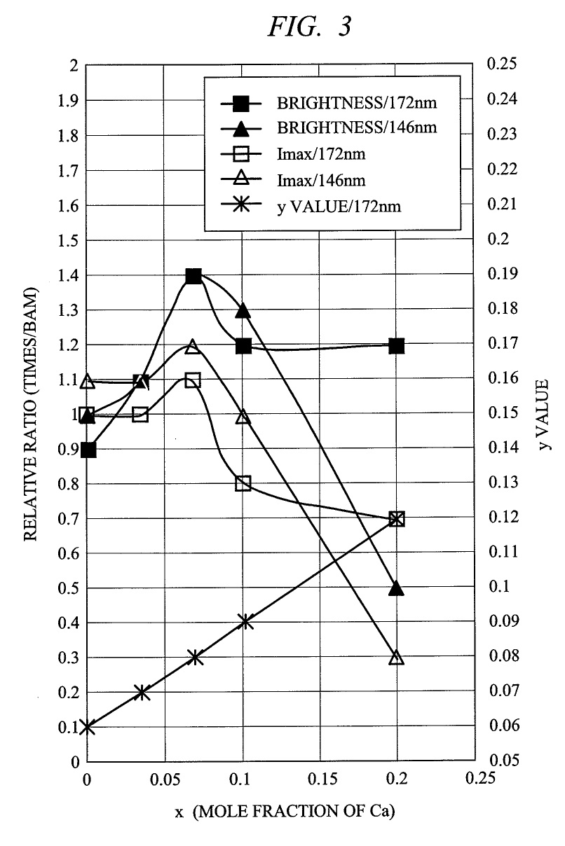

FIG. 3 is a graph showing the relationship between the emission characteristics and the mole fraction of Ca of the novel Eu-activated silicate phosphor of the present invention. In other words, for each phosphor used in FIG. 2, the relative ratio (magnification) with respect to the corresponding evaluation data of BAM was calculated. Then, the calculation results were plotted with respect to the mole fraction (x) of Ca of each phosphor. Moreover, using the evaluation results of the intensity of the maximum of the emission band of the emission spectrum obtained by the excitation of 172 nm and the excitation of 146 nm, the relative ratio (magnification) with respect to the corresponding evaluation data of BAM was calculated. Then, the calculation results were plotted with respect to the mole fraction (x) of Ca of each phosphor. Furthermore, the y value of the chromaticity (x, y) of the emission light was plotted with respect to the mole fraction (x) of Ca of each phosphor.

First, from the evaluation of the brightness upon excitation by light at a wavelength of 172 nm on the examples of the Eu-activated silicate phosphors of the present invention, the following results were obtained. (Ca_{0.034}Sr_{0.966})_{2.93}MgSi₂O₈:Eu_{0.07}, (Ca_{0.068}Sr_{0.932})_{2.93}MgSi₂O₈:Eu_{0.07}, (Ca_{0.101}Sr_{0.899})_{2.93}MgSi₂O₈:Eu_{0.07}, and (Ca_{0.20}Sr_{0.80})_{2.93}MgSi₂O₈:Eu_{0.07} respectively have brightness of 1.1, 1.4, 1.2, and 1.2 times as high as the brightness of BAM, respectively. It means that, each of the above-described Eu-activated silicate phosphors of the present invention has a photoluminescent brightness higher than that of BAM.

On the other hand, Sr_{2.93}MgSi₂O₈:Eu_{0.07} not containing a Ca component as the comparative example has a photoluminescent brightness 0.9 times as high as that of BAM so that the brightness is lower than BAM. Therefore, all the above Eu-activated silicate phosphors of the present invention have a photoluminescent brightness further higher than that of Sr_{2.93}MgSi₂O₈:Eu_{0.07} not containing a Ca component as the comparative example.

From the results of the above brightness evaluation upon excitation by light at a wavelength of 172 nm, all the above Eu-activated silicate phosphors of the present invention have a photoluminescent brightness higher than that of BAM or CMS when the mole fraction (x) of Ca is in the range of 0<x≦0.2.

Next, in the evaluation of the brightness upon excitation by light at a wavelength of 146 nm, the examples of the Eu-activated silicate phosphors of the present invention show the following results. (Ca_{0.034}Sr_{0.966})_{2.93}MgSi₂O₈: Eu_{0.07}, (Ca_{0.068}Sr_{0.932})_{2.93}MgSi₂O₈:Eu_{0.07}, and (Ca_{0.101}Sr_{0.899})_{2.93}MgSi₂O₈:Eu_{0.07} have brightness of 1.1 times, 1.4 times, and 1.3 times as high as that of BAM, respectively. It means that, these Eu-activated silicate phosphors have photoluminescent brightness higher than that of BAM. On the other hand, (Ca_{0.20}Sr_{0.80})_{2.93}MgSi₂O₈:Eu_{0.07} has a brightness 0.5 times as high as that of BAM so that it has a brightness lower than that of BAM. From these results, by the estimate of the graph of FIG. 3, the ratio with respect to BAM is 1 time or less when the mole fraction (x) of Ca is in a range of about 0.14 or more.

Moreover, Sr_{2.93}MgSi₂O₈:Eu_{0.07} not containing a Ca component has a photoluminescent brightness 0.9 times as high as that of BAM, i.e., it is lower than that of BAM. Therefore, among the above Eu-activated silicate phosphors of the present invention, (Ca_{0.034}Sr_{0.966})_{2.93}MgSi₂O₈:Eu_{0.07}, (Ca_{0.068}Sr_{0.932})_{2.93}MgSi₂O₈:Eu_{0.07}, and (Ca_{0.101}Sr_{1.899})_{2.93}MgSi₂O₈:Eu_{0.07} have photoluminescent brightness higher than that of Sr_{2.93}MgSi₂O₈:Eu_{0.07} not containing a Ca component.

From the above results, when considering to realize high photoluminescent brightness by excitation by ultraviolet light at a wavelength of 146 nm, the above Eu-activated silicate phosphors of the present invention preferably have the mole fraction (x) of Ca in a range of more than 0 and less than 0.14. In particular, an example of the novel Eu-activated silicate phosphors of the present invention of (Ca_{0.06}Sr_{0.932})₂₉₃MgSi₂O₈:Eu_{0.07} shows a photoluminescent brightness 1.4 times as high as that of BAM in both excitation by light at a wavelength of 172 nm and that of 146 nm. It means that the brightness is remarkably improved in comparison also to (Ca_{0.101}Sr_{0.899})_{2.93}MgSi₂O₈:Eu_{0.07} as an example of the phosphor to be described later.

According to a comparison to CMS as another conventional phosphor, an example of the novel Eu-activated silicate phosphors of the present invention (Ca_{0.068}Sr_{0.932})_{2.93}MgSi₂O₈:Eu_{0.07} shows a photoluminescent brightness of 7 times as high as that of CMS in excitation by light at a wavelength of 172 nm and 2 times as high as that of CMS also in excitation by light at a wavelength of 146 nm so that a remarkably high brightness can be provided.

Moreover, according to (Ca_{0.101}Sr_{0.899})_{2.93}MgSi₂O_{8:}Eu_{0.07} having a content of Ca component as the lattice component higher than that of (Ca_{0.068}Sr_{0.932})_{2.93}MgSi₂O₈:Eu_{0.07} and the mole fraction (x) of Ca of x≧0.1, the photoluminescent brightness was dramatically improved with respect to BAM both in excitation by light at a wavelength of 172 nm and excitation by light at a wavelength of 146 nm. However, the degree of the improvement is lower than that of (Ca_{0.068}Sr_{0.932})_{2.93}MgSi₂O₈:Eu_{0.07} More specifically, in the case of excitation by ultraviolet light at a wavelength of 146 nm, the brightness is 1.3 times as high as that of BAM, and in the case of excitation by ultraviolet light at a wavelength of 172 nm, the brightness is 1.2 times as high as that of BAM. Therefore, the decline of the degree of improvement was larger in the excitation of 172 nm.

From the above results with adding the estimate from the graph of FIG. 3, in the evaluation of brightness in excitation by light at a wavelength of 172 nm of the novel Eu-activated silicate phosphors of the present invention, in the region where the mole fraction (x) of Ca is 0.02 or more, the brightness is dramatically improved so as to be higher than that of BAM, and in the region where the mole fraction (x) of Ca is about 0.04, a high brightness close to 1.2 times as high as that of BAM is shown. Moreover, the brightness is rapidly lowered in a range where the mole fraction (x) of Ca is 0.07 to 0.1, and over 0.1, the change in brightness value becomes small and the rapid brightness change converges. When the mole fraction (x) of Ca is 0.101 and 0.2, the brightness of the same value which is 1.2 times as high as that of BAM is shown. As a result, it was found out that the phenomenon of having a steep characteristic improvement expressed in the region where the mole fraction (x) of Ca is 0.02 or more, and thereafter, the brightness specifically gets high before the mole fraction (x) of Ca becomes 0.1. Therefore, the steep change to higher brightness which could not be expected conventionally is expressed in the composition range of 0.02 or more of the mole fraction (x) of Ca, and a phosphor having a specific high brightness can be provided. And, a phosphor capable of realizing specific high-brightness characteristics in a range where the mole fraction (x) of Ca is 0.04 or more and 0.1 or less.

And, according to the evaluation of the brightness upon excitation by light at a wavelength of 146 nm of the novel Eu-activated silicate phosphors of the present invention, the brightness is drastically improved in a region where the mole fraction (x) of Ca is more than 0, and the high brightness close to 1.2 times as high as that of BAM is shown at the mole fraction (x) of Ca of about 0.04. Further, in a region where the mole fraction (x) of Ca is more than 0.10, the brightness starts to be lowered and it shows the brightness of about 1.2 times as high as that of BAM at the mole fraction (x) of Ca of 0.12, and about 1 time as high as that of BAM at the mole fraction (x) of Ca of 0.14. In other words, in the range where the mole fraction (x) of Ca is more than 0 and 0.14 or less, a region where the brightness is higher than that of BAM appears. Accordingly, a phosphor capable of realizing the specific high brightness characteristics can be provided particularly in the composition range where the mole fraction (x) of Ca is more than 0 and 0.14 or less.

Next, the dependency of brightness characteristic of the novel Eu-activated silicate phosphors of the present invention with respect to the wavelength of the phosphor-exciting ultraviolet light will be discussed. First, as shown in FIG. 3, the dependency of the photoluminescent brightness with respect to the Ca component content upon excitation by light at a wavelength of 172 nm of the novel Eu-activated silicate phosphors of the present invention changes from 0.9 times to 1.4 times at maximum as high as that of BAM considering the comparative example data included. Moreover, as to (Ca_{0.101}Sr_{0.899})_{2.93}MgSi₂O₈:Eu_{0.07} with the mole fraction (x) of Ca satisfying x≧0.1, the photoluminescent brightness is 1.2 times as high as that of BAM so that the degree of improvement is lowered.

On the other hand, the dependency of the photoluminescent brightness upon excitation by light at a wavelength of 146 nm on the Ca component content similarly changes from 1.0 time to 1.4 times at maximum as high as that of BAM. Moreover, as to (Ca_{0.101}Sr_{0.899})_{2.93}MgSi₂O₈:Eu_{0.07} with the mole fraction (x) of Ca satisfying x≧0.1, it is 1.3 times as high as that of BAM so that the degree of the improvement is lowered.

Therefore, according to the novel Eu-activated silicate phosphor of the present invention, (Ca_{0.068}Sr_{0.932})_{2.93}MgSi₂O₈:Eu_{0.07} having the mole fraction (x) of Ca of 0.068 has the photoluminescent brightness of 1.4 times as high as that of BAM as a result of both excitation by light at a wavelength of 172 nm and that of 14 nm. However, in (Ca_{0.101}Sr_{0.899})_{2.93}MgSi₂O₈:Eu_{0.07} with further increased mole fraction (x) of Ca, the relative brightness value with respect to BAM differs depending on the wavelength of the ultraviolet light. More specifically, upon excitation by light at a wavelength of 172 nm, the brightness value is steeply lowered to 1.2 times as high as that of BAM, and upon excitation by light at a wavelength of 146 nm, the brightness value is lowered moderately to 1.3 times as high as that of BAM.

Therefore, in excitation by light at a wavelength of 172 nm, it is apparently shown in FIG. 3 that the dependency of the photoluminescent brightness on the Ca component content is more significant as compared to that of 146 nm. In other words, the optimum range of the Ca content appears steeply and clearly so that it is clear that the Ca content is an important parameter and constituent factor at the same time. Accordingly, it was fount out that optimization of the Ca content in the novel Eu-activated silicate phosphor of the present invention is more important in consideration to excitation by light at a wavelength of 172 nm to be the mainstream in the trend of the “high xenon content” technique of the so-called plasma display panel.

Next, the ratio of the intensity of the maximum of emission band as a result of excitation by vacuum ultraviolet light at a wavelength of 172 nm was evaluated. In general, in the evaluation of the light emission characteristic of phosphors and the comparison of the phosphors, the better emission efficiency a phosphor has, the higher the total light intensity is with respect to excitation light with the same intensity. For example, in the case of Eu²⁺ activation having the same emission center with an emission spectrum (emission characteristic) in the same shape, the total intensity of light, i.e., the emission efficiency can be compared in a simple method by evaluating the emission spectra and comparing the intensity of the maximum of the emission band of the spectra.

As a result, it was found out that among the novel Eu-activated silicate phosphors of the present invention, (Ca_{0.034}Sr_{0.966})_{2.93}MgSi₂O₈:Eu_{0.07} has an intensity ratio of the maximum of the emission band (corresponding to “Imax/172 nm” in FIG. 3) in the emission spectrum at the same level as that of BAM in the emission spectrum. Moreover, (Ca_{0.068}Sr_{0.932})_{2.93}MgSi₂O₈:Eu_{0.07} has an intensity ratio larger than that of BAM, i.e., 1.1 times as strong as that of BAM. It indicates that the emission efficiency is at an extremely high level compared to the conventional phosphors.

And, with the mole fraction (x) of Ca satisfying x≧0.1, (Ca_{0.101}Sr_{0.899})_{2.93}MgSi₂O₈:Eu_{0.07} has an intensity 0.8 times as strong as that of BAM, and (Ca_{0.20}Sr_{0.80})_{2.93}MgSi₂O₈:Eu_{0.07} has an intensity ratio 0.7 times as strong as that of BAM. Therefore, although they have high emission efficiency, the emission efficiency is slightly poorer than that of BAM.

Moreover, according to a comparison of these phosphors and Sr_{2.93}MgSi₂O₈:Eu_{0.07} not containing the Ca component, since Sr_{2.93}MgSi₂O₈:Eu_{0.07} has the intensity of the maximum of the emission band at the same level as BAM, it was found out that (Ca_{0.034}Sr_{0.966})_{2.93}MgSi₂O₈:Eu_{0.07} has an intensity of the maximum of the emission band at the same level as Sr_{2.93}MgSi₂O₈:Eu_{0.07}. Further, according to a comparison of the values in more details, (Ca_{0.034}Sr_{0.966})_{2.93}MgSi₂O₈:Eu_{0.07} shows an intensity of the maximum of the emission band 1.01 times as strong as that of Sr_{2.93}MgSi₂O₈:Eu_{0.07}. Therefore, (Ca_{0.034}Sr_{0.966})_{2.93}MgSi₂O_{8:}Eu_{0.07} has a slightly larger intensity of the maximum of the emission band, and furthermore, (Ca_{0.068}Sr_{0.932})_{2.93}MgSi₂O₈:Eu_{0.07} has an intensity of the maximum of the emission band 1.1 times as strong as that of BAM so as to be apparently larger than that of BAM. This means that (Ca_{0.034}Sr_{0.966})_{2.93}MgSi₂O₈:Eu_{0.07} and (Ca_{0.068}Sr_{0.932})_{2.93}MgSi₂O₈:Eu_{0.07} have higher emission efficiencies than that of Sr_{2.93}MgSi₂O₈:Eu_{0.07} not containing a Ca component.

Moreover, according to the estimate from the graph shown in FIG. 3, phosphors with the mole fraction (x) of Ca in a range of 0.08 to 0.1 have lower emission efficiency than that of BAM and that of Sr_{2.93}MgSi₂O₈:Eu_{0.07} not containing the Ca component. That is, phosphors with the mole fraction (x) of Ca of x>0.08 have slightly poorer emission efficiency than that of BAM.

From the results of the evaluation of the intensity of the maximum of the emission band of the light emission spectra upon excitation at a wavelength of 172 nm mentioned above, according to the above Eu-activated silicate phosphors of the present invention, the Ca content with a mole fraction (x) of Ca satisfying 0<x≦0.08 is preferable from the viewpoint of realizing extremely high emission efficiency more than that of BAM.

Next, the ratio of the intensity of the maximum of emission band as a result of excitation by vacuum ultraviolet light at a wavelength of 146 nm was evaluated. The novel Eu-activated silicate phosphor of the present invention has an intensity ratio of the maximum of the emission band in the emission spectrum (corresponding to “Imax/146 nm” in FIG. 3) that (Ca_{0.034}Sr_{0.966})_{2.93}MgSi₂O₈:Eu_{0.07 and (Ca}_{0.068}Sr_{0.932})_{2.93}MgSi₂O₈:Eu_{0.07} respectively have 1.1 times and 1.2 times larger than that of BAM, respectively. The result indicates that the intensity of the maximum emission band is improved compared to BAM and extremely high emission efficiency is achieved compared to the conventional phosphors.

On the other hand, (Ca_{0.101}Sr_{0.899})_{2.93}MgSi₂O₈:Eu_{0.07} with the mole fraction (x) of Ca satisfying x≧0.1, the intensity of the maximum emission band is equivalent to BAM, i.e., 1.0 time as strong as that of BAM, and (Ca_{0.20}Sr_{0.80})_{2.93}MgSi₂O₈:Eu_{0.07} has the intensity of the maximum emission band 0.3 times as strong as that of BAM. Accordingly, the two phosphors have ratios of the intensity of the maximum of the emission band equivalent to or poorer than that of BAM.

Moreover, according to comparison of the novel Eu-activated silicate phosphors of the present invention and Sr_{2.93}MgSi₂O₈:Eu_{0.07} not containing the Ca component, Sr_{2.93}MgSi₂O₈:Eu_{0.07} has the ratio of the intensity of the maximum of the emission band 1.1 times as strong as that of BAM. Therefore, (Ca_{0.034}Sr_{0.966})_{2.93}MgSi₂O₈:Eu_{0.07} has the ratio of the intensity of the maximum of the emission band as the same level as that of Sr_{2.93}MgSi₂O₈:Eu_{0.07}, thus (Ca_{0.068}Sr_{0.932})_{2.93}MgSi₂O_{8:}Eu_{0.07} has an apparently larger ratio of the intensity.

This means that (Ca_{0.034}Sr_{0.966})_{2.93}MgSi₂O₈:Eu_{0.07} and (Ca_{0.068}Sr_{0.932})_{2.93}MgSi₂O_{8:}Eu_{0.07} have emission efficiencies equivalent to or higher than Sr_{2.93}MgSi₂O₈:Eu_{0.07} not containing the Ca component. And, in comparison to Sr_{2.93}MgSi₂O₈:Eu_{0.07} not containing a Ca component, from the graph shown in FIG. 3, it can be estimated that the ratio of the intensity of the maximum of the emission band is equivalent to or lower than Sr_{2.93}MgSi₂O₈:Eu_{0.07} not containing a Ca component a range where the mole fraction (x) of Ca is 0.08<x<0.1. In other words, the ratio of the intensity of the maximum of the emission band starts to be lower than that of Sr_{2.93}MgSi₂O₈:Eu_{0.07} in a range where the mole fraction (x) of Ca is 0.08<x.

From the evaluation of the ratio of the intensity of the maximum of the emission band by the above excitation by vacuum ultraviolet light at a wavelength of 146 nm, according to the novel Eu-activated silicate phosphors of the present invention, it was found out that the mole fraction (x) of Ca preferably satisfies 0<x<0.1 from the viewpoint of the emission efficiency improvement of the phosphor emission in comparison to the conventional phosphors such as BAM. Furthermore, it was also found out that it is more preferable to satisfy x≦0.08 from the viewpoint of effects of the further emission efficiency improvement by the addition of a Ca component.

Next, dependency of the intensity of the maximum of the emission band of the novel Eu-activated silicate phosphors of the present invention on the wavelength of ultraviolet light for exciting phosphors will be discussed. As shown in FIG. 3, with data of the comparative examples taken into consideration, first, the dependency of the novel Eu-activated silicate phosphors of the present invention on the Ca component content of the ratio with the intensity of the maximum of the emission band upon excitation by light at a wavelength of 172 nm varies from 1.0 time to 1.1 times at most as compared to BAM. And, as to (Ca_{0.101}Sr_{0.899})₂₉₃MgSi₂O₈:Eu_{0.07} with the mole fraction (x) of Ca satisfying x≧0.1, it is 0.8 times as strong as that of BAM so that the degree of the improvement is lowered. Similarly, the dependency of the photoluminescent brightness upon excitation at a wavelength of 146 nm on the Ca component content varies from 1.1 times to 1.2 times at most with respect to BAM. And, as to (Ca_{0.101}Sr_{0.899})_{2.93}MgSi₂O₈:Eu_{0.07} with the mole fraction (x) of Ca satisfying x≧0.1, it is 1.0 time as high as that of BAM so that the degree of the improvement is lowered.

In other words, among the novel Eu-activated silicate phosphors of the present invention, (Ca_{0.068}Sr_{0.932})_{2.93}MgSi₂O₈:Eu_{0.07} with the mole fraction (x) of Ca of 0.068 has the ratio of the intensity 1.1 times as strong as that of BAM upon excitation by light at a wavelength of 172 nm. Moreover, it is 1.2 times as strong as BAM upon excitation by light at a wavelength of 146 nm. Therefore, in both conditions, it shows extremely high ratios of the intensity of the maximum of the emission band as to the photoluminescent brightness.

However, in the case of (Ca_{0.101}Sr_{0.899})_{2.93}MgSi₂O₈:Eu_{0.07} with the mole fraction of Ca further increased, the ratio of the intensity of the maximum of the emission band is lowered in both conditions. And, the degree of the decline differs depending on the wavelength of the ultraviolet light to be used. In other words, upon excitation by light at a wavelength of 172 nm, it is lowered steeply from 1.1 times to 0.8 times as strong as that of BAM. However, upon excitation by light at a wavelength of 146 nm, it is lowered slightly moderately from 1.2 times to 1.0 time as strong as that of BAM. Then, as it is shown clearly in FIG. 3, the dependency of the emission efficiency on the Ca component content is more remarkable in the case of excitation by light at a wavelength of 172 nm than in that of 146 nm. Consequently, the optimum range of the Ca content appears more steeply and clearly so that it was learned that the Ca content provides a more important parameter and constituent element in the case of excitation by light at a wavelength of 172 nm.

Accordingly, it was found out that optimization of the Ca content of the novel Eu-activated silicate phosphor of the present invention is more important in consideration to excitation by light at a wavelength of 172 nm becomes the mainstream in the trend of “high xenon content” technique of the so-called plasma display panel.

Next, as to each example of phosphors, the emission color characteristics by the excitation by vacuum ultraviolet light (wavelengths: 146 nm and 172 nm) were evaluated. Among the color characteristics, as to the color reproductivity, in the case of color display of an image on a display, realization of wider color reproductivity such as ensuring of the color reproduction range of 100% or more with respect to NTSC is desired. Therefore, in the case of ensuring 100% or more with respect to NTSC, as to the chromaticity (x, y) of the blue light emission phosphor in the CIE chromaticity coordinates, it is preferable that the x value and y value each has a value close to or lower than the blue chromaticity (x, y) (0.14, 0.08) defined by the NTSC.

As a result of the discussion, as shown in the table of FIG. 2, it was found out that the color characteristics of the light emission from the above phosphors upon excitation by light at a wavelength of 172 nm and the color characteristics of the light emission from the above phosphors upon excitation by light at a wavelength of 146 have no differences so that in both conditions the same x value and y value are shown in the chromaticity (x, y) of the emission color of the above phosphors.

From the results shown in FIG. 2, the x value and y value of the chromaticity (x, y) of the light emitted from (Ca_{0.034}Sr_{0.966})_{2.93}MgSi₂O₈:Eu_{0.07} are respectively (x, y)=(0.14, 0.07). As a comparative example, for example, the values of the blue chromaticity defined by the NTSC of the color TV currently spread are (x, y)=(0.14, 0.08). Therefore, compared to the values, it was found out that higher color purity with a smaller y value can be obtained. Moreover, the x value and the y value of the chromaticity (x, y) of the light emitted from (Ca_{0.068}Sr_{0.932})_{2.93}MgSi₂O₈:Eu_{0.07} are respectively (x, y)=(0.14, 0.08) so that it was found out that the similar color characteristics as the blue color defined in the NTSC are obtained. Furthermore, as to (Ca_{0.101}Sr_{0.899})_{2.93}MgSi₂O₈:Eu_{0.07} having the content of the Ca component contained as the host lattice component larger than that of (Ca_{0.068}Sr_{0.932})_{2.93}MgSi₂O₈:Eu_{0.07}, with the mole fraction (x) of Ca satisfying x≧0.1, the x value and the y value of the chromaticity (x, y) of the emitted light are respectively (x, y)=(0.14, 0.09). Therefore, it was found out that, although the excellent color characteristics are provided, the y value of the chromaticity (x, y) is slightly larger compared to the blue color defined in the NTSC.

From the results mentioned above, according to the novel Eu-activated silicate phosphors of the present invention, it was learned that with the increase of the Ca content, the emission color purity starts to be lowered little by little. Moreover, as to (Ca_{0.20}Sr_{0.80})_{2.93}MgSi₂O₈:Eu_{0.07}, the x value and the y value of the chromaticity (x, y) of the emitted light are each (x, y)=(0.14, 0.12) so that it was learned that the y value is larger than the chromaticity (x, y) of the blue color in the NTSC.

From the above-mentioned results and FIG. 3, according to the novel Eu-activated silicate phosphors of the present invention, as to the mole fraction of the contained Ca component, the more Ca content is increased, the larger y value in the chromaticity (x, y) of the light emitted from the phosphor becomes. Further, as mentioned above, according to (Ca_{0.101}Sr_{0.899})_{2.93}MgSi₂O₈:Eu_{0.07} with the mole fraction (x) of Ca satisfying x≧0, the x value and y value of the chromaticity (x, y) of the emitted light are (x, y)=(0.14, 0.09) so that the y value in the chromaticity (x, y) is slightly larger than those of the blue color defined in the NTSC. Therefore, for having the y value in the chromaticity of the emitted light in an appropriate range and having the emission color performance, in particular, the color purity appropriately, it is preferable that the Ca content is smaller than that of (Ca_{0.101}Sr_{0.899})_{2.93}MgSi₂O₈:Eu_{0.07}.

In other words, according to the novel Eu-activated silicate phosphors of the present invention, from the viewpoint of the color characteristics of the phosphor light emission, for having the y value of the chromaticity (x, y) of the light emission as a value close to that of the blue color defined in the NTSC, it is preferable that the mole fraction (x) of Ca satisfies x≦1. Moreover, in addition to the result, from the relationship between the mole fraction (x) of Ca in each phosphor shown in the graph of FIG. 3 and the y value of the chromaticity (x, y) of the emitted light, the optimum composition range of the component Ca of the novel Eu-activated silicate phosphor of the present invention can be estimated that the mole fraction (x) of Ca preferably satisfies x≦0.9 for having the y value of the chromaticity (x, y) of the light emission close to the y value of the chromaticity (x, y) of the blue color defined in the NTSC.

Based on FIG. 3, it was found out that the y value of the chromaticity (x, y) of the light emission in the novel Eu-activated silicate phosphors of the present invention is equivalent to or lower than the y value (0.08) of the chromaticity (x, y) of the blue color defined in the NTSC when the mole fraction (x) of Ca is in a range of x≦0.07. Moreover, the y value of the chromaticity (x, y) of the light emission from (Ca_{0.068}Sr_{0.932})_{2.93}MgSi₂O₈:Eu_{0.07} is 0.08 as shown in FIG. 2. Therefore, according to the novel Eu-activated silicate phosphors of the present invention, in order to realize a practical value based on the y value of the chromaticity (x, y) of the light emission equivalent to or lower than that of the blue color defined in the NTSC, it is more preferable that the mole fraction (x) of Ca is x≦0.08.

Next, some description will be added to the lower limit of the mole fraction (x) of Ca is set to satisfy 0<x. In the present invention, setting the lower limit of the mole fraction (x) of Ca larger than 0 (0<x) with the premise that Ca is added means that a Ca component material is used intentionally so that the Ca component is contained when synthesizing the phosphor. In other words, it means that when synthesizing the above Eu-activated silicate phosphors of the present invention with a Ca component included as a composition, the Ca component material is used clearly so as to be blended with the other materials for synthesizing the phosphor.

On the other hand, for example, a Mg material compound, an Eu material compound, or the like used as an ordinary material when synthesizing an ordinary phosphor containing a Mg component and an Eu component may contain a Ca component material as a minute amount of impurities. In other words, in the phosphor containing a Mg or Eu component synthesized without intentionally containing a Ca component may contain an extremely minute amount of Ca component such as several ppm to several tens of ppm. Therefore, even in the phosphors without intentional inclusion of the Ca component or description of the inclusion, the content of the Ca component may be revealed by detailed analysis of the composition by means of analysis, or the like.

Therefore, such a phosphor unintentionally including a Ca composition therein, i.e., including a Ca component as an impurity and the novel Eu-activated silicate phosphors of the present invention including a Ca component apparently intentionally as well as making the optimum range of the composition ratio clear should be clearly distinguished from each other. For the distinction, in the novel Eu-activated silicate phosphors of the present invention, when providing a composition of Ca component in the phosphor synthesizing process, the amount to be substantially controlled is preferably set as the lower limit of the content of Ca component.

Therefore, according to the novel Eu-activated silicate phosphors of the present invention, the lower limit of the Ca component content is set afresh in consideration to the following conditions. The amount of Ca component to be included as the impurity is in the order of several ppm to several tens of ppm (several mg to several tens of mg in 1000 g) even in the case using a high purity synthetic material of, for example, 99.9% or more. Further, the amount of Ca component substantially controllable is about 0.1 mg (10 ppm) when synthesizing a small amount of the phosphor of about 10 g at the so-called laboratory demonstration, and furthermore, the molecular weight is not largely different between a Mg compound and a corresponding similar Ca compound in general.

Accordingly, for the novel Eu-activated silicate phosphors of the present invention, with the assumption that the content of the Ca component is about 100 ppm or more, the lower limit of the mole fraction (x) of Ca can be set at x=0.0001.

Further, with the clear distinction with the unintentional inclusion and in consideration to the fact that it may be eliminated even in the case of using a phosphor material with low purity, for realizing the clear distinction, it is preferable that the lower limit of the Ca component content is about 10 times as large as the above value so that the lower limit of the mole fraction (x) of Ca is x=0.001.

Furthermore, in consideration to the amount to be included unintentionally in the case of using a phosphor material with low purity, for realizing the clear distinction, it is preferable that the lower limit of the Ca component content is about 100 times as large as the above value so that the lower limit of the mole fraction (x) of Ca is x=0.01.

Consequently, according to the novel Eu-activated silicate phosphors of the present invention, in the case of adding the Ca component in consideration of photoluminescent brightness, the intensity of the maximum of the emission band and the chromaticity of the emitted light, and clearly presenting the optimum range of the Ca mole fraction, the lower limit of the mole fraction (x) of Ca can be set at x=0.0001. Moreover, the mole fraction (x) of Ca is preferably 0.001≦x, and more preferably 0.01≦x.

In the foregoing, the description of the present invention such as 0<x, 0.001<x, or the like is a disclosure including any of the above cases of lower limit setting. Therefore, from the brightness evaluation results upon excitation by ultraviolet light at a wavelength of 172 nm, according to the above Eu-activated silicate phosphors of the present invention, it is preferable to set the mole fraction (x) of Ca to be 0.001≦x≦0.2 as to the preferable Ca content, and it is further preferable to be 0.01≦x≦0.2.

Based on the above-mentioned photoluminescent brightness, the intensity of the maximum of the emission band, and the evaluation results on the light emission chromaticity and description thereof, a description about a preferable content of the phosphor component Ca in the above Eu-activated silicate phosphors of the present invention will be summarized hereafter.

From the viewpoint of the brightness evaluation upon excitation by ultraviolet light at a wavelength of 172 nm and the emission efficiency evaluation by the evaluation of the intensity of the maximum of the emission band in the emission spectrum upon excitation by ultraviolet light at a wavelength of 172 nm, as to the Ca content of the above Eu-activated silicate phosphors of the present invention, it is preferable that the mole fraction (x) of Ca satisfies 0<x≦0.2. Moreover, in consideration to the photoluminescent brightness obtained as a result of excitation by ultraviolet light at a wavelength of the 146 nm, the Ca content of the above Eu-activated silicate phosphors of the present invention preferably satisfies 0.001≦x≦0.14.

Furthermore, from the viewpoints of: improvement of the emission efficiency of the phosphor light emission as comparing to the conventional phosphors such as BAM according to the evaluation of the intensity of the maximum of the emission band upon excitation by vacuum ultraviolet light at a wavelength of 146 nm; improvement of the emission efficiency both in excitation by vacuum ultraviolet light at a wavelength of 172 nm and that of 146 nm; the above-mentioned color characteristics of the emitted light; and achieving them at the same time, it is preferable that the mole fraction (x) of Ca of the novel Eu-activated silicate phosphors of the present invention preferably satisfies 0.001≦x<0.1.

On the other hand, as to the novel Eu-activated silicate phosphors of the present invention, to have a chromaticity (x, y) of the color of the emitted light closer to the chromaticity of the blue color defined by the NTSC, i.e., to have the y value of the chromaticity (x, y) of the emitted light color further closer to that of the blue chromaticity defined by the NTSC, the mole fraction (x) of Ca of the novel Eu-activated silicate phosphors of the present invention more preferably satisfies 0.001≦x≦0.9. Moreover, from the viewpoints of: the effect of improvement of the emission efficiency of the phosphors by composition of the Ca component in comparison to Sr_{2.93}MgSi₂O₈:Eu_{0.07} not containing a Ca component according to the evaluation of the intensity of the maximum of the emission band as a result of excitation by vacuum ultraviolet light at 146 nm; ensuring a wider color reproductivity of the above phosphor light emission; and achieving them at the same time, the mole fraction (x) of Ca more preferably satisfies 0.001≦x≦0.08. Furthermore, in consideration to the drastic brightness improvement in a region where the mole fraction (x) of Ca is 0.02 or more in the evaluation of the brightness in the excitation by vacuum ultraviolet light at a wavelength of 172 nm, the fraction (x) of Ca more preferably satisfies 0.02≦x≦0.08.

From the foregoing, it was found out that, by providing a plasma display panel (PDP) of the present invention using the novel Eu-activated silicate phosphor with the range of the mole fraction of Ca optimized as described above, a PDP with high luminance, high efficiency and wide color reproductivity and a plasma display device with high luminance, high efficiency and wide color reproductivity can be realized.

Note that, the novel Eu-activated silicate phosphors of the present invention represented by the above-mentioned General Formula (1) is applicable to light emitting devices other than the PDP such as flat-panel fluorescent lamps using rare gas discharge, and three band white fluorescent lamps so as to provide a blue-emitting phosphor. That is, as a result of using the novel Eu-activated silicate phosphor of the present invention represented by the above-mentioned General Formula (1), a highly reliable light emitting device such as flat-panel fluorescent lamps using rare gas discharge and three band white fluorescent lamps can be realized with high luminance, high efficiency and wide color reproductivity.

Next, the relationship between the effect of the high Xe content in the PDP and the present invention will be described. As described above, as to the PDP, it is known that the more the mole fraction of Xe in the discharge gas is increased, the more the entire amount of vacuum ultraviolet light to be generated is increased, and the more the ratio of intensity of the maximum of the emission band (I₁₇₂/I₁₄₆) of the wavelength ultraviolet light component of 146 nm and that of 172 nm (Xe₂ molecular line) is increased.

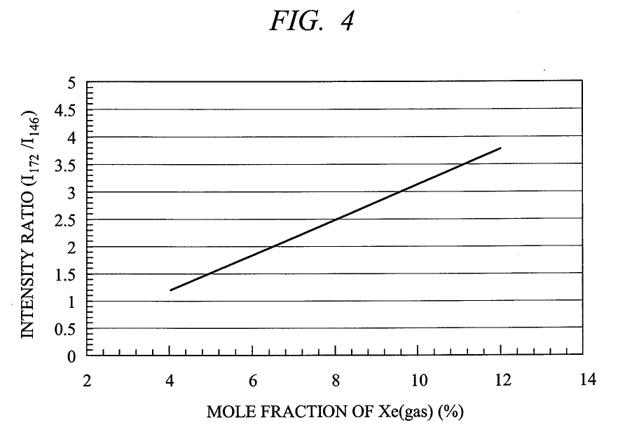

FIG. 4 is a graph showing the relationship between the mole fraction (%) of Xe in the discharge gas in an AC PDP and the intensity ratio (I₁₇₂/I₁₄₆). As a result of the investigations, according to the AC PDP, when the mole fraction of Xe is 4% the intensity ratio is I₁₇₂/I₁₄₆ (4%) 1.2. According to conventional PDPs having the mole fraction of Xe of 1 to 4%, as to the intensity ratio of the ultraviolet light component at 146 nm and the ultraviolet light component at 172 nm included in the vacuum ultraviolet light generated by the discharge, the intensity of the 172 nm component is somewhat larger or equal or rather smaller than that of the 146 nm component.

Moreover, as a result of further investigations, with the mole fraction of Xe of 6%, as the entire intensity of vacuum ultraviolet light to be generated by the discharge is increased, the ratio of I₁₇₂ and I₁₄₆ drastically gets larger, i.e., I₁₇₂/I₁₄₆ (6%)=1.9. And, at the mole fraction of Xe of 10%, as the intensity of vacuum ultraviolet light to be generated by the discharge is further increased, the ratio of I₁₇₂ and I₁₄₆ drastically gets larger, i.e., I₁₇₂/I₁₄₆ (10%)=3.1. Moreover, with the ratio of the mole fraction of Xe of 12%, it was found out that, as the intensity of vacuum ultraviolet light to be generated by the discharge is more increased, the ratio of I₁₇₂ and I₁₄₆ gets extremely larger, i.e., I₁₇₂/I₁₄₆ (12%) 3.8.

Therefore, according to the high-Xe content PDP designs having a mole fraction of Xe of, for example, 6% which is larger than the PDP with the ordinary specification in the mole fraction of Xe in the discharge gas, contribution of the characteristics of the phosphors to be used to the 172 nm vacuum ultraviolet light gets larger. Therefore, it is preferable to use a phosphor which achieves light emission with higher characteristics such as high brightness with respect to the 172 nm wavelength ultraviolet light.

Furthermore, when setting the mole fraction of Xe further higher, i.e., 10% or more to achieve light emission with further higher efficiency, demands for the performance of phosphors to obtain light emission with further better characteristics such as higher brightness with respect to the 172 nm wavelength ultraviolet light is still higher. Moreover, when setting the mole fraction of Xe further higher, i.e., 10% or more to achieve light emission with further higher efficiency, since the intensity ratio is I₁₇₂/I₁₄₆ (12%)=3.8, which is extremely high, demands for the performance of phosphors to obtain light emission with further better characteristics such as higher brightness with respect to the 172 nm wavelength ultraviolet light is further higher.

As described above, when the novel Eu-activated silicate phosphors of the present invention represented by the above-mentioned General Formula (1) is used for the PDP using a discharge gas containing a Xe composition, since preferable emission characteristics can be obtained by the phosphors as a result of excitation by light at a wavelength of 172 nm as well as that of 146 nm, the Xe₂ molecular line to be generated can also be utilized effectively so that a high performance PDP can be provided.

Moreover, according the novel Eu-activated silicate phosphors of the present invention represented by the above-mentioned General Formula (1) can be preferably matched with the so-called “high Xe-content PDP designs” technology of using a discharge gas containing Xe gas, for example, in a mole fraction of Xe=6% or more, more preferably 10% or more with an intensity ratio of the ultraviolet light component at 172 nm and the ultraviolet light component at 146 nm (Xe₂ molecular line is utilized actively) large, and further preferably, mole fraction of Xe=12% or more with I₁₇₂/I₁₄₆ (12%)=3.8, which is remarkably large. Thereby, a high performance PDP using a discharge gas with a high Xe-content can be realized.

Consequently, according to the novel Eu-activated silicate phosphors of the present invention represented by the above-mentioned General Formula (1), the dependency of emission efficiency and photoluminescent brightness on the Ca component content is more remarkable in the excitation by ultraviolet light at 172 nm than that of 146 nm so that the optimum range of the Ca content is more clear. Therefore, upon excitation by ultraviolet light essentially at 172 nm, in terms of brightness, efficiency, or the like, more significant effects and remarkable characteristics can be realized.

Therefore, when the novel Eu-activated silicate phosphors of the present invention represented by the above-mentioned General Formula (1) are used for a PDP using a discharge gas containing Xe composition to have the mole fraction of 6% or more, more preferably 10% or more, and further preferably 12% or more, since the excellent emission characteristics can be shown effectively utilizing Xe₂ molecular line generated in the PDP, a high performance PDP can be provided so that a high performance plasma display device can be provided as well.

Based on the foregoing description, an embodiment of the AC PDP using the Eu-activated silicate phosphors of the present invention represented by the above-mentioned General Formula (1) is configured as follows.

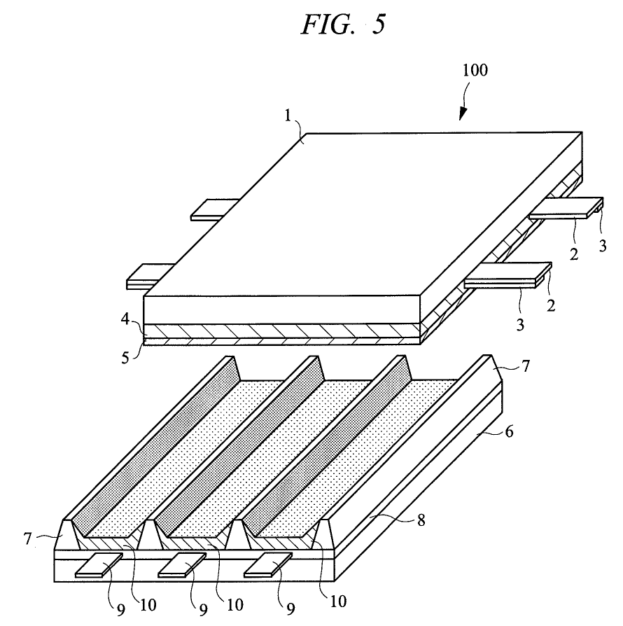

FIG. 5 is an exploded perspective view of main parts showing an example of configuration of main parts of a PDP. The PDP 100 as an embodiment of the present invention having a structure corresponding to so-called surface discharge includes: a pair of substrates 1, 6 arranged at a distance so as to face each other; barrier ribs 7 arranged on a facing side of the substrate 6 for keeping the distance between the substrates 1, 6 when they are superimposed and forming a space between the substrates 1, 6; electrodes 2, 9 arranged on the facing sides of the substrates 1, 6; and a discharge gas (not shown) sealed in the space formed between the substrates 1 and 6 for generating ultraviolet light as a result of electric discharge upon application of a voltage to the electrode 2 or the electrodes 2, 9. And, a phosphor layer 10 containing the Eu-activated silicate phosphor represented by the above-mentioned General Formula (1) is formed on one of the facing sides of the pair of substrates 1, 6 (substrate 6 side) and on wall surfaces of the barrier rib 7. The phosphor layer 10 normally includes phosphors corresponding to light emission of three colors including red, blue, and green, i.e., a red-emitting phosphor, a blue-emitting phosphor or a green-emitting phosphor such that the Eu-activated silicate phosphor represented by the above-mentioned General Formula (1) for providing blue color in the phosphor layer 10 and the phosphors for providing the other colors (red and green) are excited by vacuum ultraviolet light of 146 nm and 172 nm wavelengths generated from the above-mentioned discharge gas by the electric discharge for emitting visible light. Note that, a line indicated by the reference numeral 3 shown in FIG. 5 is a bus-line made of Ag or Cu—Cr provided integrally with the electrode 2 for lowering electrode resistance, layers indicated by the reference numerals 4, 8 are dielectric layers, and a layer indicated by the reference the numeral 5 is a protective film provided for protecting the electrode. Hereinafter, embodiments corresponding to best modes for carrying out the invention will be explained.

### First Embodiment

To produce a plasma display panel as a first embodiment of the present invention, first, an Eu-activated silicate phosphor as an essential constituent member of the present invention is synthesized.

For the synthesis of a phosphor having a composition formula (Ca_{0.034}Sr_{0.966})_{2.93}MgSi₂O₈:Eu_{0.07}, first, 0.100 g (1.00 mmol) of CaCO₃, 4.178 g (28.30 mmol) of SrCO₃, 0.962 g (10.00 mmol) of MgCO₃, 1.202 g (20.00 mmol) of SiO₂, 0.1230 g (0.350 mmol) of Eu₂O₃, and 0.392 g (4.00 mmol) of NH₄Br as a flux are respectively weighed and fully mixed in an agate mortar. Thereafter, the obtained mixture is charged into a heat-stable vessel and heated for 3 hours at 1000° C. in the atmosphere. Thereafter, it is further heated for 3 hours at 1200° C. in a reducing atmosphere. The obtained product is pulverized, washed with water and dried so as to obtain a silicate phosphor of the above composition.

Next, for the synthesis of a phosphor (Ca_{0.068}Sr_{0.932})_{2.93}MgSi₂O₈ :Eu_{0.07}, in the same manner as described above, 0.200 g (2.00 mmol) of CaCO₃, 4.030 g (27.30 mmol) of SrCO₃, 0.962 g (10.00 mmol) of MgCO₃, 1.202 g (20.00 mmol) of SiO₂, 0.1230 g (0.350 mmol) of Eu₂O₃, and 0.392 g (4.00 mmol) of NH₄Br as a flux are respectively weighed and fully mixed in an agate mortar. Thereafter, the obtained mixture is charged into a heat-stable vessel and heated for 3 hours at 800° C. in the atmosphere. Thereafter, it is further heated for 3 hours at 1200° C. in a reducing atmosphere. The obtained product is pulverized, washed with water and dried so as to obtain a silicate phosphor of the above composition.

Next, a phosphor (Ca_{0.101}Sr_{0.899})_{2.93}MgSi₂O₈:Eu_{0.07} with the mole fraction (x) of Ca of x≧0.1 is synthesized. Synthesis was carried out in the same manner as described above, 0.296 g (2.95 mmol) of CaCO₃, 3.889 g (26.34 mmol) of SrCO₃, 0.962 g (10.00 mmol) of MgCO₃, 1.202 g (20.00 mmol) of SiO₂, 0.1230 g (0.350 mmol) of Eu₂O₃, and 0.392 g (4.00 mmol) of NH₄Br as a flux were respectively weighed and fully mixed in an agate mortar. Thereafter, the obtained mixture is charged into a heat-stable vessel and heated for 3 hours at 800° C. in the atmosphere. Thereafter, it is further heated for 3 hours at 1200° C. in a reducing atmosphere. The obtained product is pulverized, washed with water and dried so as to obtain a silicate phosphor of the above composition.

Moreover, another phosphor (Ca_{0.20}Sr_{0.80})_{2.93}MgSi₂O_{8:} Eu_{0.07} with the mole fraction (x) of Ca of x≧0.1 is synthesized. Synthesis is carried out in the same manner as described above, 0.5865 g (5.86 mmol) of CaCO₃, 3.460 g (23.44 mmol) of SrCO₃, 0.962 g (10.00 mmol) of MgCO₃, 1.202 g (20.00 mmol) of SiO₂, 0.1230 g (0.350 mmol) of Eu₂O₃, and 0.392 g (4.00 mmol) of NH₄Br as a flux are respectively weighed and fully mixed in an agate mortar. Thereafter, the obtained mixture is charged into a heat-stable vessel and heated for 3 hours at 800° C. in an atmospheric pressure. Thereafter, it is heated further for 3 hours at 1200° C. in a reducing atmosphere. The obtained product is pulverized, washed with water and dried so as to obtain a silicate phosphor of the above composition.

For the synthesis of a phosphor (Sr_{2.93}MgSi₂O₈:Eu_{0.07}) as a comparative example, SrCO₃ of 4.326 g (29.30 mmol), MgCO₃ of 0.962 g (10.00 mmol), SiO₂ of 1.202 g (20.00 mmol), Eu₂O₃ of 0.1230 g (0.350 mmol), and NH₄Br of 0.392 g (4.00 mmol) as a flux are respectively weighed and fully mixed in an agate mortar. Thereafter, the obtained mixture is charged into a heat-stable vessel and heated for 3 hours at 1000° C. in the atmosphere. Thereafter, it is further heated for 3 hours at 1200° C. in a reducing atmosphere. The obtained product is pulverized, washed with water and dried so as to obtain a silicate phosphor of the above composition (comparative example).

### Second Embodiment

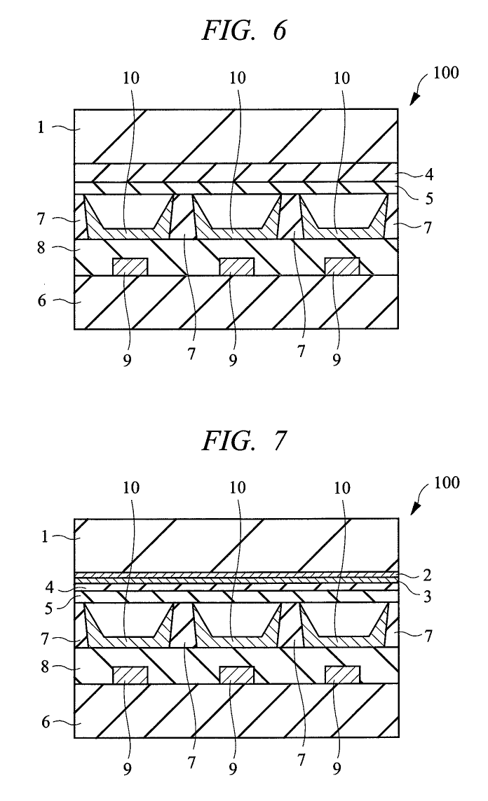

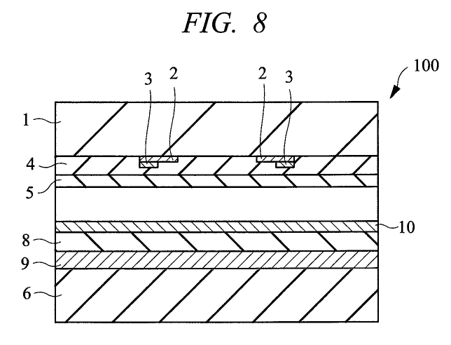

For evaluating the novel Eu-activated silicate phosphors of the present invention as well as the characteristics and the reliability of the PDP using the same as the light emitting device of the present invention, as two phosphors to configure the phosphor layer, (Ca_{0.068}Sr_{0.932})₂₉₃MgSi₂O₈:Eu_{0.07} as the silicate phosphor of the present invention synthesized in the first embodiment and BAM as the conventional blue-emitting phosphor are used and the plasma display panel (PDP) 100 shown in FIGS. 5 to 8 is prepared. FIG. 5 is an exploded perspective view of main parts showing the structure of the PDP of an embodiment of the present invention. Moreover, FIGS. 6, 7, 8 are cross-sectional views showing main parts of the structure of PDP according to an embodiment of the present invention.

For preparing the PDP 100, first, after forming the address electrode 9 made of Ag or the like, and the dielectric layer 4 made of a glass-based material on the rear substrate 6, a barrier rib material similarly made of a glass-based material is printed as a thick film, and the barrier rib 7 is formed by blasting using a blast mask. Next, the phosphor layer 10 is formed on the barrier rib 7 in a stripe-like form so as to cover a groove surface (wall surface) between the barrier ribs 7.

Here, the phosphor layers 10 are respectively formed by preparing a phosphor paste by mixing 35 parts by weight of a blue-emitting phosphor particle and 65 parts by weight of a vehicle. After applying them by screen printing, they are subjected to drying and heating to evaporate volatile components and burn-off organic substances in the phosphor paste. The phosphor particles used in the phosphor layers 10 has a particle diameter of 1 to 10 μm.

One display region of PDP where the phosphor layer 10 is provided if divided into two for convenience so as to have display regions that have substantially same areas. One of the regions is provided with only the phosphor layer 10 including (Ca_{0.068}Sr_{0.932})_{2.93}MgSi₂O₈:Eu_{0.07} as the blue-emitting phosphor layer, and the other region is provided with only the phosphor layer 10 including BAM as the blue-emitting phosphor to compare and contrast. In other words, in one PDP, two kinds of phosphors including (Ca_{0.068}Sr_{0.932})_{2.93}MgSi₂O₈:Eu_{0.07} are applied separately on two different display regions having the same area so that the PDP 100 is a PDP for emitting only one blue color.

Therefore, when driving the PDP 100, (Ca_{0.068}Sr_{0.932})_{2.93}MgSi₂O₈:Eu_{0.07} and BAM emit light at the same time by the discharge in the PDP 100 so that the PDP 100 emits light. Thereby, characteristics (deterioration characteristics and lifetime characteristics) of (Ca_{0.068}Sr_{0.932})_{2.93}MgSi₂O₈:Eu_{0.07} of the present invention and BAM as the conventional phosphor can be compared and evaluated in the same discharge environment in the same PDP.

Next, after the front substrate 1 bearing display electrodes 2, bus-electrodes 3, the dielectric layer 4 and the protective layer 5 is sealed with the back substrate 6 with a frit and the inside of the panel is evacuated, a discharge gas is charged into the panel, and the panel is sealed. The discharge gas is a gas mixture mainly contains neon (Ne) as the principal material and xenon (Xe) gas having the mole fraction of 4%.

The PDP 100 according to the present embodiment has the display region of a square shape whose size is 100 mm×100 mm. To produce the conventional color display, the phosphor layers 10 are sequentially applied by phosphor layers made of phosphors corresponding to emissions of three colors of red (R), green (G) and blue (B), respectively. One pixel has a pitch of 1000 μm×1000 μm.

In the PDP of surface-discharge color plasma display devices as shown in the present embodiment, a negative voltage is applied to one of the display electrodes 2 (generally referred to as “scanning electrode”) and a positive voltage (a positive voltage as compared with the voltage applied to the scanning electrode 2) is applied to the address electrode 9 and the other display electrode 2 so as to allow discharge. This makes a wall charge between the pair of display electrodes, serving as an auxiliary for initiating discharge. This is referred to as “write.” A suitable reverse voltage is applied between the pair of display electrodes 2 in this state, resulting in discharge via the dielectric 4 (and the protective layer 5) in a discharge space between the two electrodes. After the completion of discharge, the voltage applied to the display electrodes 2 is reversed so as to induce another discharge. Discharge occurs continuously by repeating this procedure. This is referred to as sustain discharge or display discharge.

Next, a plasma display device is prepared by using the PDP 100 including (Ca_{0.068}Sr_{0.932})_{2.93}MgSi₂O₈:Eu_{0.07} according to the present invention and the conventional BAM described above, discharge and lighting drive were enabled in combination with a driving circuit. By using the plasma display device, the sustain discharge pulse of 220 V voltage and 100 kHz frequency is applied for drive, discharge and lighting. And, as to each lighting display region separated by the above phosphors, the brightness (Br) of the blue emission in the initial lighting, and the chromaticity (x, y) as the color characteristics of the emitted blue light are evaluated. Then, by using the y value of the obtained chromaticity (x, y), the evaluated brightness (Br) is divided by the y value, to calculate Br/y as a parameter for easy evaluation of the emission efficiency. Then, the Br/y value calculated here is provided as the initial value.

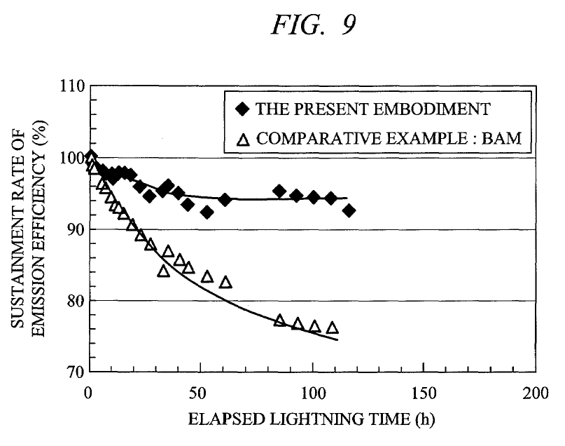

Thereafter, as the lifetime test, driving and lighting are continued so as to light for about 100 hours. During the period, (Br/y) is evaluated per predetermined time. Then, the ratio of the above-mentioned (Br/y) value in the initial lighting and the (Br/y) value after the predetermined time passed is calculated. Further, by using the calculated ratio, the deterioration characteristics of (Ca_{0.068}Sr_{0.932})_{2.93}MgSi₂O₈:Eu_{0.07} of the present invention and BAM are compared as the sustain ratio of emission efficiency (Br/y) FIG. 9 is a graph obtained by plotting the change in sustainment ratio of emission efficiency (%) with time of the PDP using (Ca_{0.068}Sr_{0.932})_{2.93}MgSi₂O₈:Eu_{0.07} of the present invention and the PDP using BAM as the comparative example. In FIG. 9, the situation of the emission performance lowering due to the deterioration of the phosphors promoted as lighting time passes with respect to the initial value (Br/y) evaluated in each region provided with each phosphor is taken as the ratio with respect to the initial (Br/y) value (emission efficiency sustainment ratio). It is recorded per phosphor provided in each region with respect to the elapsed lighting time (In FIG. 9, shown as “the present embodiment” and “BAM”).

According to FIG. 9, in the PDP 100, in the display region provided with (Ca_{0.068}Sr_{0.932})_{2.93}MgSi₂O₈:Eu_{0.07} of the present invention, the sustainment ratio to be lowered with time, i.e., lowering of emission efficiency (and brightness) is very small. On the other hand, in the display region provided with the conventional BAM, emission efficiency is lowered drastically. This means that, in the display region provided with (Ca_{0.068}Sr_{0.932})_{2.93}MgSi₂O₈:Eu_{0.07}, the sustainment ratio of emission efficiency is about 95%, while it is about 75% in the display region provided with BAM.

From the results described above, in the PDP, deterioration during lighting is less in the display region provided with (Ca_{0.068}Sr_{0.932})_{2.93}MgSi₂O₈:Eu_{0.07} of the present invention than in the display region provided with the conventional BAM. This means that the novel Eu-activated silicate phosphor (Ca_{0.068}Sr_{0.932})_{2.93}MgSi₂O₈:Eu_{0.07} of the present invention may not be prone to pose deterioration by lighting than the conventional BAM so that it has a high reliability. Therefore, a highly reliable PDP to be hardly deteriorated can be provided by use of the novel Eu-activated silicate phosphor of the present invention.

### Third Embodiment

Using phosphors of three colors of the novel Eu-activated silicate blue-emitting phosphor of the present invention (Ca_{0.068}Sr_{0.932})_{2.93}MgSi₂O₈:Eu_{0.07}, a red-emitting phosphor, and a green-emitting phosphor, a color PDP is prepared as a light emitting device capable of color display.

The structure of the color PDP of the present embodiment is same as the PDP 100 shown in FIGS. 5 to 8, but it is different therefrom in that the phosphor layers corresponding to the three color light emission are provided like stripes successively over a front surface of the display region for enabling the color display. Therefore, since details of the other configuration and the method of preparation are same as those of the second embodiment, the description thereof is omitted.

In the preparation process in the second embodiment, the phosphor layers 10 corresponding to color emission of red (R), green (G), blue (B), respectively are formed on the barrier ribs 7 so as to cover the groove surface between the barrier ribs 7 like stripes successively. Here, the phosphor layers 10 corresponding to respective emissions of red (R), green (G), blue (B) are formed by preparing phosphor pastes by mixing 40 parts by weight of red-emitting phosphor particles and 60 parts by weight of a vehicle, 40 parts by weight of green-emitting phosphor particles and 60 parts by weight of a vehicle, and 35 parts by weight of blue-emitting phosphor particles and 65 parts by weight of a vehicle. After applying them by screen printing, they are subjected to drying and heating to evaporate volatile components and burn-off organic substances in the phosphor paste. The phosphor particles used in the phosphor layers 10 of the present embodiment has a particle diameter of 1 to 10 μm.

Moreover, as to the materials of the phosphors other than the novel blue-emitting phosphor (Ca_{0.068}Sr_{0.932})_{2.93}MgSi₂O₈:Eu_{0.07} of the present invention, the red-emitting phosphor is a 1:1 mixture of a (Y, Gd) BO₃:Eu phosphor and a Y₂O₃:Eu phosphor, and the green-emitting phosphor is a Zn₂SiO₄:Mn phosphor. The color PDP accordingly produced has a wide color reproductivity, high luminance and long life.

Although detailed investigation results are not described for the red and green phosphors in the present embodiment, PDP can be prepared in the same manner also with the phosphors of each composition listed below. For example, as the red-emitting phosphor, at least one phosphor selected from the group consisting of: (Y, Gd)BO₃:Eu; (Y, Gd)₂O₃:Eu; and (Y, Gd) (P, V)0₄:Eu can be used. And, as the green-emitting phosphor, at least one phosphor selected from the group consisting of: Zn₂SiO₄:Mn; (Y, Gd, Sc)₂SiO₅:Tb; (Y, Gd)₃(Al, Ga)₅O₁₂:Tb; (Y, Gd)₃(Al, Ga)₅O₁₂:Ce; (Y, Gd)B₃O₆:Tb; and (Y, Gd)PO₄:Tb can be used. Furthermore, a combination with a phosphor not shown here is applicable.

Further, as the blue-emitting phosphor, for realizing the desired characteristics in consideration to the color characteristics or the like, together with the Eu-activated silicate phosphor represented by the above-mentioned General Formula (1) such as (Ca_{0.068}Sr_{0.932})_{2.93}MgSi₂O₈:Eu_{0.07} mentioned above, at least one phosphor selected from the group consisting of: BaMgAl₁₀O₁₇:Eu; CaMgSi₂O₆:Eu; and Sr₃MgSi₂O₈:Eu as the conventional blue-emitting phosphors may be used in combination.

In the foregoing, the invention made by the inventors of the present invention has been concretely described based on the embodiments. However, it is needless to say that the present invention is not limited to the foregoing embodiments and various modifications and alterations can be made within the scope of the present invention.

The present invention can be utilized for a PDP using the Eu-activated silicate phosphor to emit light by excitation by ultraviolet light, and furthermore, it can be utilized for a plasma display device to display video with a driving circuit for driving the PDP and a video source.

What is claimed is:

1. A plasma display device comprising:
a pair of substrates arranged at a distance so as to face each other;
barrier ribs arranged between the pair of substrates and formed between the pair of substrates;
an electrode pair arranged on at least one of facing sides of the pair of substrates;
a discharge gas sealed in the space formed by the barrier ribs for generating ultraviolet light as a result of electric discharge upon application of a voltage to the electrode pair; and
a phosphor layer containing a phosphor for emitting light as a result of excitation by the ultraviolet light formed on at least one of the f acing sides of the pair of substrates and wall surfaces of the barrier ribs in the space,
wherein the phosphor contains an Eu-activated silicate phosphor represented by the following General Formula (1):
(CaₓM1₁₋ₓ)₃₋ₑ.M2Si₂O₈:Euₑ (1)
wherein M1 is at least one element selected from the group consisting of Sr and Ba; M2 is at least one element selected from the group consisting of Mg and Zn; and x is the mole fraction of the component Ca, and e is the mole fraction of Eu, respectively satisfy the following conditions: 0<x≦0.2, and 0.001≦e≦0.2.

2. The plasma display device according to claim 1,
wherein the mole fraction x of the component Ca of the Eu-activated silicate phosphor represented by the General Formula (1) satisfies the following condition: 0.001≦x<0.1.

3. The plasma display device according to claim 2,
wherein the mole fraction x of the component Ca satisfies the following condition: 0.001≦x<0.09.

4. The plasma display device according to claim 3,
wherein the mole fraction x of the component Ca satisfies the following condition: 0.02≦x<0.08.

5. The plasma display device according to claim 1,
wherein the discharge gas contains Xe in a mole fraction of 6% or more.

6. The plasma display device according to claim 5,
wherein the discharge gas contains Xe in a mole fraction of 10% or more.

7. The plasma display device according to claim 6,
wherein the discharge gas contains Xe in a mole fraction of 12% or more.

8. The plasma display device according to claim 5,
wherein a phosphor layer of either of a red-emitting phosphor, a green-emitting phosphor, and a blue-emitting phosphor is formed in each space, and the blue-emitting phosphor includes the Eu-activated silicate phosphor represented by the General Formula (1).

9. The plasma display device according to claim 8,
wherein the blue-emitting phosphor includes, in addition to the Eu-activated silicate phosphor represented by the General Formula (1), at least one phosphor selected from the group consisting of BaMgAl₁₀O₁₇:Eu, CaMgSi₂O₆:Eu, and Sr₃MgSi₂O₈:Eu.

10. The plasma display device according to claim 8,
wherein the red-emitting phosphor is comprised of at least one phosphor selected from the group consisting of: (Y, Gd)BO₃:Eu; Y₂O₃:Eu; (Y, Gd)₂O₃:Eu; and (Y, Gd) (P, V)O₄:Eu, and the green phosphor is comprised of at least one phosphor selected from the group consisting of: Zn₂SiO₄:Mn; (Y, Gd, Sc)₂SiO₅:Tb; (Y, Gd)₃(Al, Ga)₅O₁₂:Tb; (Y, Gd)₃(Al, Ga)₅O₁₂:Ce; (Y, Gd)B₃O₆:Tb; and (Y, Gd)PO₄:Tb.

11. A light emitting device comprising:
an electrode pair;
a discharge gas for generating ultraviolet light as a result of electric discharge upon application of a voltage to the electrode pair; and
a phosphor layer containing a phosphor for emitting light upon excitation by the ultraviolet light,
wherein the phosphor contains an Eu-activated silicate phosphor represented by the following General Formula (1):
(CaₓM1₁₋ₓ)₃₋ₑM2Si₂O₈:Euₑ (1)
wherein M1 is at least one element selected from the group consisting of Sr and Ba; M2 is at least one element selected from the group consisting of Mg and Zn; and x is the mole fraction of the component Ca, and e is the mole fraction of Eu, respectively satisfy the following conditions: 0<x≦0.2, and 0.001≦e≦0.2.
